(19) United States
(12) Patent Application Publication
(10) Pub. No.: US 2010/0228958 A1
(43) Pub. Date: Sep. 9, 2010

(54) INFORMATION PROCESSING APPARATUS, METHOD FOR CONTROLLING INFORMATION PROCESSING APPARATUS AND COMPUTER READABLE MEDIUM

(75) Inventors: Takao NAITO, Kanagawa (JP); Kazuo YAMADA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/537,886

(22) Filed: Aug. 7, 2009

(30) Foreign Application Priority Data
Mar. 5, 2009 (JP) 2009-051638

(51) Int. Cl. G06F 15/177; G06F 1/24

(52) U.S. Cl. 713/1; 713/100

(57) ABSTRACT

An information processing apparatus includes a first circuit configuration section, a second circuit configuration section and a circuit configuration controller. The first circuit configuration section includes a first circuit configuration configured by a plurality of first calculation units. Each of the first calculation units has a circuit being configured to be dynamically reconfigured. The second circuit configuration section includes a second circuit configuration configured by a plurality of second calculation units. Each of the second calculation units has a fixed circuit. The circuit configuration controller controls the first circuit configuration and the second circuit configuration in accordance with processing time to be taken for performing information processing.

### CROSS-REFERENCE TO RELATED APPLICATIONS

This application is based on and claims priority under 35 USC 119 from Japanese Patent Application No. 2009-51638 filed Mar. 5, 2009.

### BACKGROUND

1. Technical Field

The present invention relates to an information processing apparatus, a method for controlling an information processing apparatus and a computer-readable medium storing a program that causes a computer to execute a process for controlling an information processing apparatus.

### SUMMARY

According to an aspect of the invention, an information processing apparatus includes a first circuit configuration section, a second circuit configuration section and a circuit configuration controller. The first circuit configuration section includes a first circuit configuration configured by a plurality of first calculation units. Each of the first calculation units has a circuit being configured to be dynamically reconfigured. The second circuit configuration section includes a second circuit configuration configured by a plurality of second calculation units. Each of the second calculation units has a fixed circuit. The circuit configuration controller controls the first circuit configuration and the second circuit configuration in accordance with processing time to be taken for performing information processing.

### BRIEF DESCRIPTION OF THE DRAWINGS

Exemplary embodiments of the invention will be described in detail based on the following figures, wherein:

FIG. 1 is a drawing describing an outline configuration of an information processing apparatus according to an exemplary embodiment of the invention:

FIG. 2 is a block diagram showing the configuration of the information processing apparatus according to the exemplary embodiment;

FIG. 3 is a drawing describing a pipeline of information processing;

FIG. 4A is a drawing showing an example of a management table;

FIG. 4B is a drawing showing an example of a selection table;

FIG. 5 is a drawing describing a flow of information processing according to the processing circuit configuration;

FIG. 6 is a drawing showing the relationship between the number of circuit reconfiguration times and the processing performance;

FIG. 7 is a flowchart describing an assignment method of the first circuit configuration section and the second circuit configuration section;

FIG. 8 is a flowchart describing first scheduling;

FIG. 9 is a diagram of a pipeline describing the first scheduling;

FIG. 10 is a timing chart describing the processing operation according to the first scheduling;

FIG. 11 is a flowchart describing second scheduling;

FIG. 12 is a diagram of a pipeline describing the second scheduling;

FIG. 13 is a timing chart describing the processing operation according to the second scheduling;

FIG. 14 is a flowchart describing third scheduling;

FIG. 15 is a diagram of a pipeline describing the third scheduling;

FIG. 16 is a timing chart describing the processing operation according to the third scheduling;

FIG. 17 is a diagram of a pipeline describing fourth scheduling;

FIG. 18 is a flowchart describing the fourth scheduling.

FIG. 19 is a diagram of the pipeline after the fourth scheduling is performed; and

FIG. 20 is a drawing showing an example of the management table after the fourth scheduling is performed.

### DETAILED DESCRIPTION

Hereinafter exemplary embodiments of the invention will be described with reference to accompanying drawings.

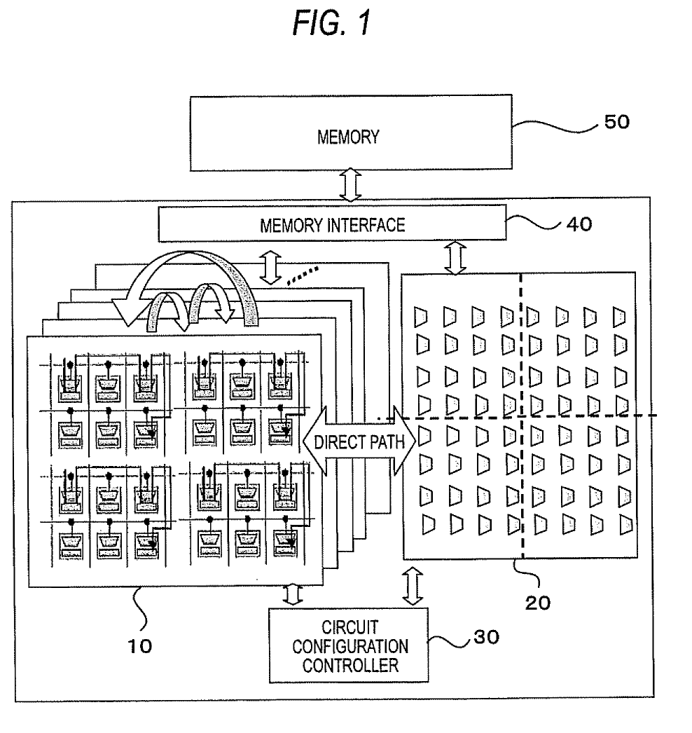

FIG. 1 is a drawing describing an outline configuration of an information processing apparatus according to an exemplary embodiment of the invention. The information processing apparatus according to the exemplary embodiment includes a first circuit configuration section 10, a second circuit configuration section 20, and a circuit configuration controller 30.

The first circuit configuration section 10 includes a plurality of first calculation units whose circuit is dynamically reconfigured. For example, a DRP (Dynamically Reconfigurable Processor) having an internal circuit reconfigured at a predetermined timing is used for the first circuit configuration section 10. The DRP is configured to reconfigure the circuit at a clock basis of several-nanoseconds.

One of the first calculation units is configured by processor elements (PEs) implemented as a plurality of calculation circuits. The first circuit configuration section 10 has a plurality of processor elements arranged in a grid layout and a predetermined information processing circuit is dynamically configured according to a combination of the processor elements.

The second circuit configuration section 20 includes a plurality of second calculation units implemented as a fixed circuit; for example, an FPGA (Field Programmable Gate Array) having an internal circuit reconfigured at a predetermined timing is used. The FPGA has the circuit reconfigured at several-clock basis of several-milliseconds.

One of the second calculation units is implemented as a single calculation circuit (logic element (LE)) such as an AND gate, an OR gate, an adder, or a subtracter. The second circuit configuration section 20 has a plurality of logic elements arranged in a grid layout and a various information processing circuit is dynamically configured according to a combination of the logic elements.

In the exemplary embodiment, the first calculation unit including a plurality of calculation circuits such as the processor elements is called a coarse-grain computing unit, and the second calculation unit including a single calculation circuit such as the logic element is called a fine-grain computing unit. According to the configuration of the computing unit, the first circuit configuration section 10 has the circuit configuration changed in a shorter time than the second circuit configuration section 20.

The circuit configuration controller 30 is a component for controlling the circuit configuration based on the first calculation units of the first circuit configuration section 10 and the circuit configuration based on the second calculation units of the second circuit configuration section 20 in response to the time taken for information processing to process predetermined information.

The circuit configuration controller 30 controls the circuit configuration to perform efficient processing as the overall information processing considering the advantage of the circuit configuration at high speed, the characteristic of the DRP of the first circuit configuration section 10, and the advantage of the large-scaled circuit configuration, the characteristic of the FPGA of the second circuit configuration section 20.

For example, to perform information processing of not using the processing result of one piece of information for processing of another piece of information, namely, not to perform processing of feeding back the processing result of one piece of information into the later information processing to perform sequential processing for a plurality of pieces of information the circuit configuration controller 30 controls so as to set the circuit configuration with the first calculation units of the first circuit configuration section 10.

To perform information processing of using the processing result of one piece of information for processing of another piece of information, namely, to perform processing of feeding back the processing result of one piece of information into the later information processing to perform sequential processing for a plurality of pieces of information, the circuit configuration controller 30 controls so as to set the circuit configuration with the second calculation units of the second circuit configuration section 20.

The circuit configuration controller 30 controls the circuit configuration using the whole or a part for each of the first circuit configuration section 10 and the second circuit configuration section 20. Information of the circuit configuration is stored in memory 50 connected to the information processing apparatus. The circuit configuration controller 30 reads information of the circuit configuration from the memory through a memory interface 40 and controls the circuit configurations of the first circuit configuration section 10 and the second circuit configuration section 20 based on the information of the circuit configuration. For the memory 50 shown in FIG. 1, a storage section for temporarily storing information to be processed and a circuit configuration storage section for storing the information of the circuit configuration are shown in common.

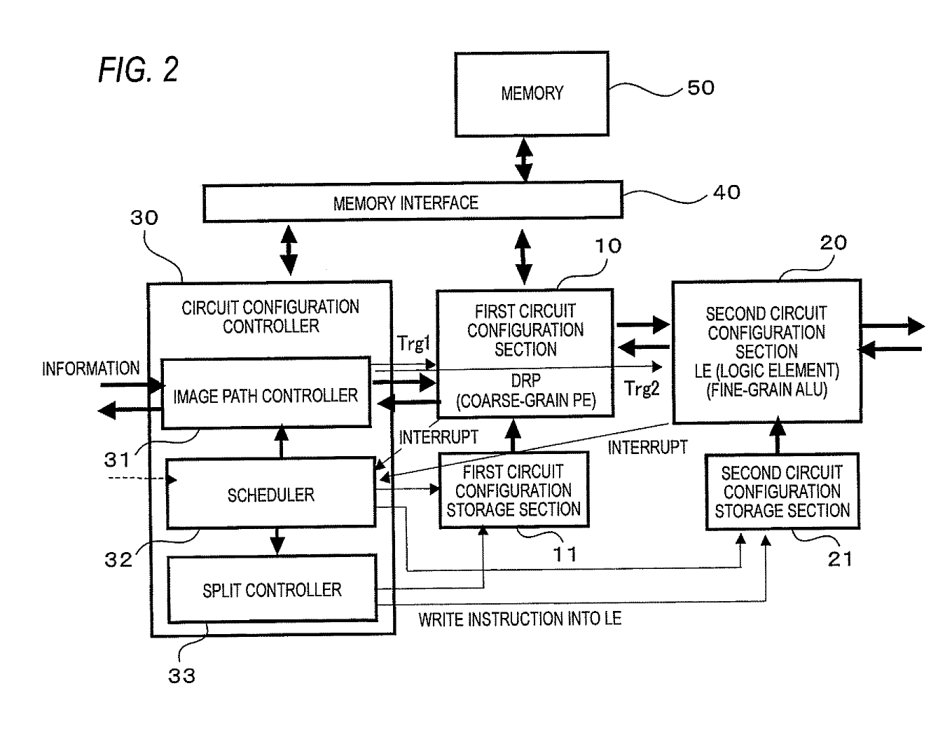

FIG. 2 is a block diagram showing the configuration of the information processing apparatus according to the exemplary embodiment of the invention. The circuit configuration controller 30 includes an information path controller 31, a scheduler 32, and a split controller 33. The information path controller 31 controls a flow of information to be processed. That is, it controls processing of sending input information to the first circuit configuration section 10 or the second circuit configuration section 20 and controls input/output of information between the first circuit configuration section 10 and the second circuit configuration section 20 and the memory 50. When performing input or output of information from or to the first circuit configuration section 10, the information path controller 31 sends a trigger Trg1 to the first circuit configuration section 10. When performing input or output of information from or to the second circuit configuration section 20, the information path controller 31 sends a trigger Trg2 to the second circuit configuration section 20.

The scheduler 32 controls the circuit configurations of the first circuit configuration section 10 and the second circuit configuration section 20 and a flow of information based on pipeline management information (management table) and interrupt signals sent from the first circuit configuration section 10 and the second circuit configuration section 20. The scheduler 32 also controls area split of the first circuit configuration section 10 and the second circuit configuration section 20.

The split controller 33 gives an area split command of the first circuit configuration section 10 and the second circuit configuration section 20 under the control of the scheduler 32. The scheduler 32 and the split controller 33 give a command to a first circuit configuration storage section 11 and give the circuit configuration stored in the first circuit configuration storage section 11 to the first circuit configuration section 10 for setting the circuit configuration. The scheduler 32 and the split controller 33 give a command to a second circuit configuration storage section 21 and give the circuit configuration stored in the second circuit configuration storage section 21 to the second circuit configuration section 20 for setting the circuit configuration.

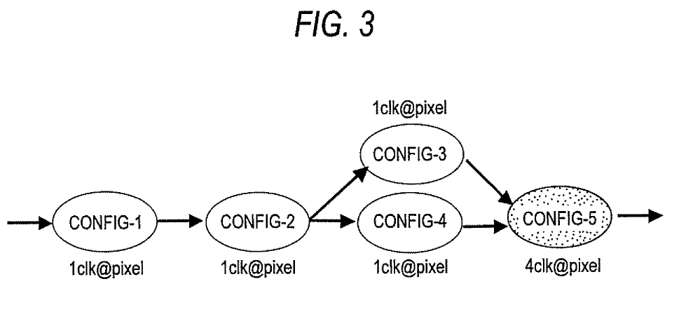

FIG. 3 is a drawing describing a pipeline of information processing. As information processing, image processing is taken as an example and a circuit for performing predetermined processing for each pixel is taken as an example. In the figure, “Config” indicates the configuration of one of the processing circuit. In the example shown in FIG. 3, “Config-1” to “Config-5” are circuit configurations and each of “Config-1” to “Config-4” is processing in a single clock per pixel and “Config-5” is processing in four clocks per pixel.

An image is sent from “Config-1” to “Config-2” in order for each pixel and is processed. The image is processed in parallel in “Config-3” and “Config-4” and is sent to “Config-5.” In “Config-5,” the one-pixel image is processed in four clocks.

The processing time in each Config is calculated from the number of pixels and the clock frequency. For example, JIS (Japanese Industrial Standards) A4-size 600-dpi (dots/per inch) image information becomes 32 megapixels in total. If the frequency of the operation clock of the information processing apparatus is 200 MHz, the processing time in one Config becomes 32 megapixels/200 MHz=160 msec (milliseconds).

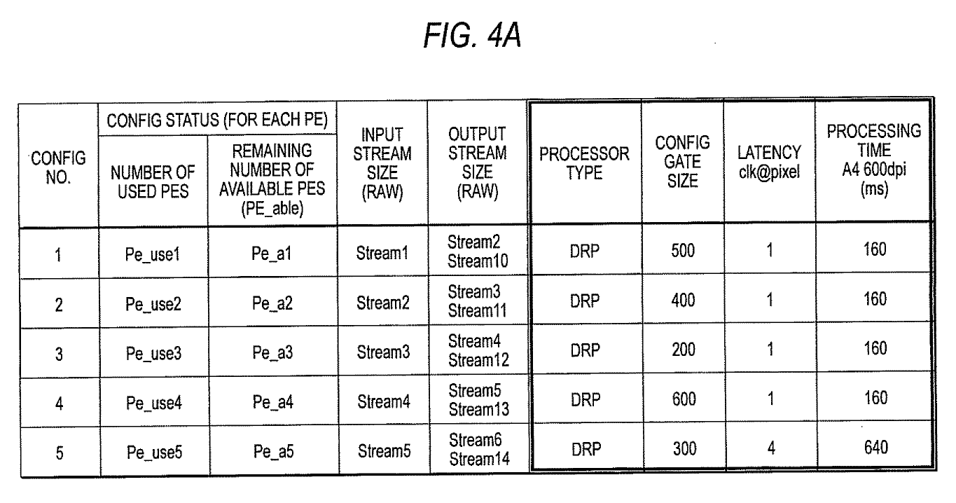

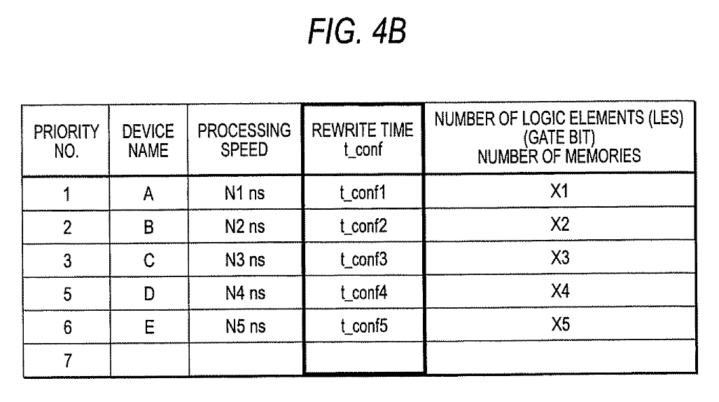

FIG. 4A is a drawing showing an example of a pipeline management table. To perform the image information pipeline processing described above, the scheduler 32 executes the circuit configuration of the first circuit configuration section 10 using the pipeline management table shown in FIG. 4A. The pipeline management table stores the number of used processor elements (PEs), the remaining number of PEs, the number of input data pieces (Input Stream Size), the number of output data pieces (Output Stream Size), the processor type, the circuit configuration size, latency (the number of delay clocks), and the processing time in association with each Config. No. of the circuit configuration. The scheduler 32 references the pipeline management table and gives a circuit configuration command.

FIG. 4B is a drawing showing an example of a selection table of logic element (LE). The scheduler 32 executes the circuit configuration of the second circuit configuration section 20 using the selection table shown in FIG. 4B. The selection table stores the device name, the processing speed, the rewrite time, the number of logic elements (Gate bit), and the number of memories in association with the selection priority. The scheduler 32 references the selection table and gives a circuit configuration command. That is, to replace with the fine-grain reconfigurable circuit (second circuit configuration section) in a portion where latency occurs in the coarse-grain reconfigurable circuit (first circuit configuration section), a candidate for the fine-grain reconfigurable circuit is selected out of the table. At the time, it is selected in the priority order and whether or not the target performance is accomplished.

Basically, the coarse-grain reconfigurable circuit (first circuit configuration section) can perform processing at higher speed and can also switch at higher speed than the fine-grain reconfigurable circuit (second circuit configuration section). However, since the coarse-grain reconfigurable circuit has a coarse grain size, latency occurs in a circuit involved in feedback, and the processing speed becomes low. On the other hand, if logical synthesis is executed in the fine-grain reconfigurable circuit, the feedback circuit is synthesized in a single clock. Thus, if the circuit portion producing the shortcoming of the coarse-grain reconfigurable circuit is replaced with the fine-grain reconfigurable circuit, the advantages of the coarse-grain and fine-grain reconfigurable circuits are utilized and the overall circuit is speeded up.

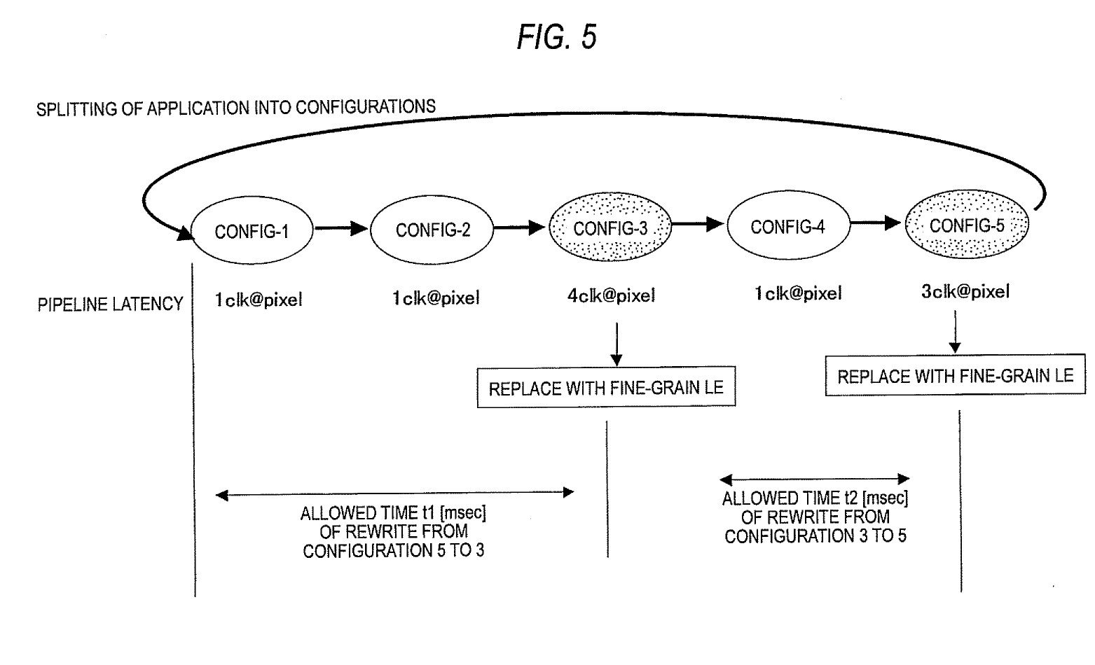

FIG. 5 is a drawing describing a flow of information processing according to the processing circuit configuration. Here, rewrite of the circuit configuration will be discussed. In the example shown in FIG. 5, “Config-1” to “Config-5” are circuit configurations and each of “Config-1,” “Config-2,” and “Config-4” is processing in a single clock per pixel, “Config-3” is processing in four clocks per pixel, and “Config-5” is processing in three clocks per pixel.

If circuit configuration is executed in the first circuit configuration section 10 (for example, DRP) as all of “Config-1” to “Config-5,” to execute “Config-1” to “Config-5” about a one-pixel image, 10 clocks become necessary in total, namely, it becomes necessary to change (rewrite) the circuit configuration in a total of 10 times.

In contrast, if configuration is executed in the second circuit configuration section 20 (for example, FPGA) about “Config-3” and “Config-5” each requiring a plurality of clocks per pixel, there is a possibility that each may be configured in a single clock per pixel and thus to execute “Config-1” to “Config-5,” five-clock processing in total is only needed.

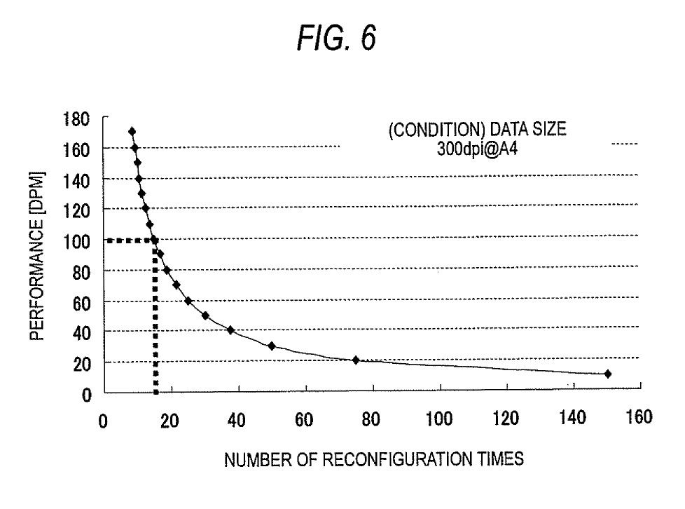

FIG. 6 is a drawing showing the relationship between the number of circuit reconfiguration times and the processing performance. In FIG. 6, the relationship between the number of circuit reconfiguration times and the processing performance (DPM: Document per minute) when A4-size, 300-dpi image information is processed is simulated. As seen in the figure, the smaller the number of circuit reconfiguration times, the higher the processing performance.

On the other hand, although a large-scale circuit configuration can be executed in the second circuit configuration section 20, the second circuit configuration section 20 does not handle high-speed circuit configuration in the first circuit configuration section 10. In the example shown in FIG. 5, the number of rewrite times is decreased by executing circuit configuration in the second circuit configuration section 20 about “Config-3” and “Config-5.” However, in the second circuit configuration section 20, rewrite time t2 from “Config-3” to “Config-5” and rewrite time t1 from “Config-5” to “Config-3” need to be within a predetermined allowed time.

In the exemplary embodiment, from the viewpoint, both the first circuit configuration section 10 for executing circuit reconfiguration at high speed and the second circuit configuration section 20 handling reconfiguration of a large-scale circuit are combined for making information processing more efficient.

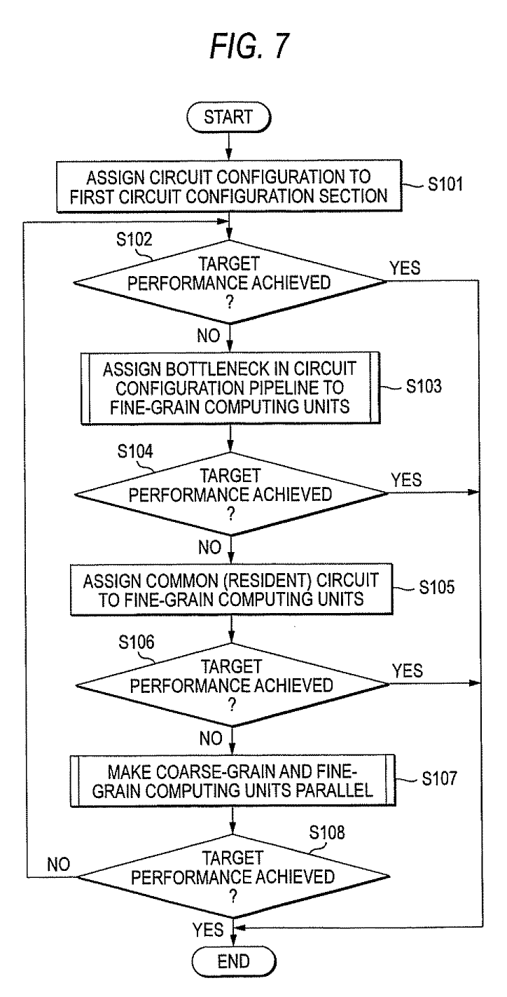

FIG. 7 is a flowchart describing an assignment method of the first circuit configuration section and the second circuit configuration section. To begin with, for any desired information processing, circuit configuration is assigned to the first circuit configuration section 10 including the coarse-grain computing units (step S101). Whether or not the processing performance of the information processing accomplishes any desired target performance in the assignment is determined (step S102). The processing performance when circuit configuration is assigned to the first circuit configuration section 10 is found by referencing the management table shown in FIG. 4A and integration of the latency and the processing time corresponding to the circuit configuration (Config). Whether or not the processing performance reaches the target performance is determined. If the target performance is reached, assignment of the circuit configuration to the first circuit configuration section 10 only is determined.

When the target performance is not reached, bottleneck in the circuit configuration pipeline is assigned to the second circuit configuration section 20 including the fine-grain computing units (step S103). Whether or not the processing performance in a state in which circuit configuration is assigned to the second circuit configuration section 20 reaches the target performance is determined (step S104). The processing performance when circuit configuration is assigned to the second circuit configuration section 20 is found by referencing the selection table shown in FIG. 4B and addition of the processing speed of the assigned device and the rewrite time. Addition with the processing performance when remaining circuit configuration is assigned to the first circuit configuration section 10 is performed, thereby finding the overall processing performance. Whether or not the processing performance reaches the target performance is determined. When the target performance is reached, assignment of the circuit configuration to the first circuit configuration section 10 and the second circuit configuration section 20 is determined.

When the target performance is not reached, for the first circuit configuration section 10 including the coarse-grain computing units, processing of assigning the configuration of a common (resident) circuit to the second circuit configuration section 20 including the fine-grain computing units is performed (step S106). When the target performance is reached, assignment of the circuit configuration to the first circuit configuration section 10 and the second circuit configuration section 20 is determined.

When the target performance is not reached, the first circuit configuration section 10 including the coarse-grain computing units and the second circuit configuration section 20 including the fine-grain computing units are made parallel (step S107) and whether or not the processing performance reaches the target performance is determined (step S108). When the target performance is reached, assignment of the circuit configuration is determined. When the target performance is not reached, the process returns to step S101 and the target performance is reconsidered and the later processing is repeated.

Assignment of the circuit configuration shown in FIG. 7 is mainly performed at the design stage of the information processing apparatus and assignment of the circuit configuration for predetermined information processing, namely, the circuit configuration in the first circuit configuration section 10 and the circuit configuration in the second circuit configuration section 20 when the predetermined information processing is performed are stored respectively in the first circuit configuration storage section 11 and the second circuit configuration storage section 21 shown in FIG. 2.

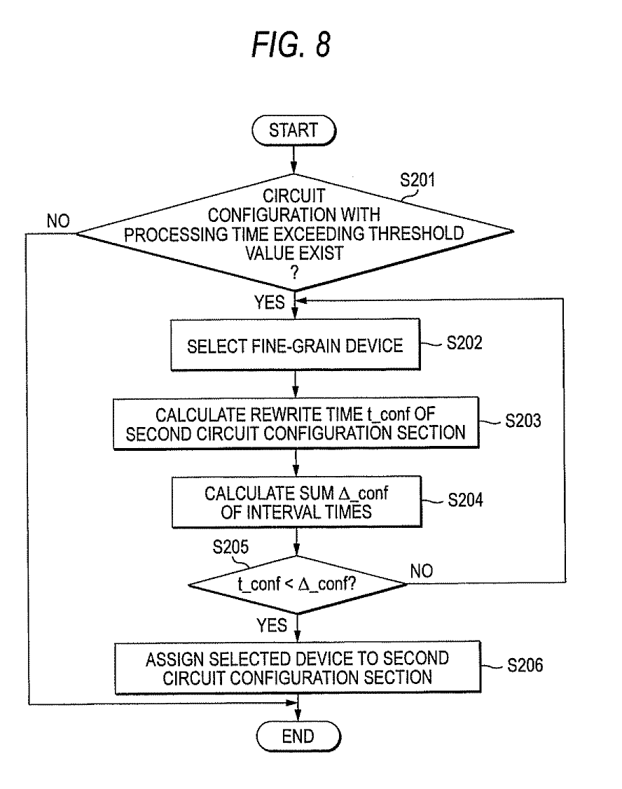

FIG. 8 is a flowchart describing first scheduling. Processing in the flowchart is executed in the scheduler 32 of the circuit configuration controller 30. To begin with, a circuit configuration with the processing time exceeding a predetermined threshold value in the circuit configuration (Config) of desired information processing is extracted (step S201). The processing time of the circuit configuration is determined by referencing the management table shown in FIG. 4A. According to the determination, for example, a circuit configuration where latency exceeding single clock occurs in processing per pixel by processing of feedback, etc., is extracted. If a circuit configuration (Config) where latency occurs is not extracted, the processing is terminated.

Next, when a circuit configuration (Config) where latency exceeding single clock occurs is extracted, for the circuit configuration, circuit configuration in the second circuit configuration section 20 including the fine-grain computing units is selected (step S202). In this processing, the selection table shown in FIG. 4B is referenced and a device (combination configuration of the fine-grain computing units) is selected in the order starting at the highest priority.

Next, rewrite time (t_conf) of the second circuit configuration section 20 when the selected device is used is calculated (step S203). The rewrite time (t_conf) is calculated according to the rewrite time per gate bit of the logic element (LE).

Next, sum Δ_conf of interval times of the circuit configurations (Config) is calculated (step S204). Whether or not the rewrite time (t_conf) is smaller than the total interval time (Δ_conf) is determined (step S205). If the rewrite time (t_conf) is smaller than the total interval time (Δ_conf), the circuit of the second circuit configuration section 20 is configured using the selected device (step S206).

On the other hand, if the rewrite time (t_conf) is not smaller than the total interval time (Δ_conf), the process returns to step S202 and the device having the next priority is selected out of the selection table and the later processing is repeated.

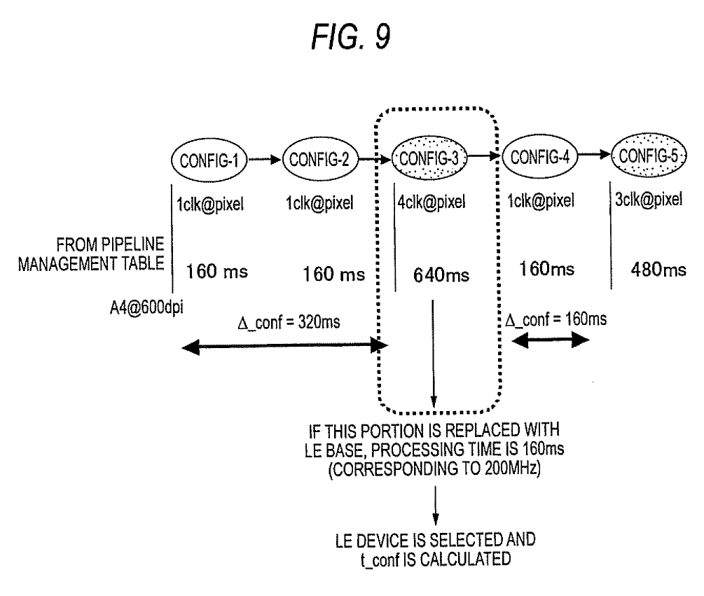

FIG. 9 is a diagram of the pipeline describing the first scheduling. In the example shown in FIG. 9. “Config-1” to “Config-5” are circuit configurations and each of “Config-1,” “Config-2,” and “Config-4” is processing in a single clock per pixel, “Config-3” is processing in four clocks per pixel, and “Config-5” is processing in three clocks per pixel. In the first scheduling, “Config-3” is extracted as a circuit configuration where latency exceeding single clock occurs.

If extracted “Config-3” is assigned to the second circuit configuration section 20 including the fine-grain computing units, the processing time becomes 160 ms like that of “Config-1,” “Config-2,” “Config-4.” The rewrite time (t_conf) when “Config-3” is assigned to the second circuit configuration section 20 is calculated. A comparison is made between the rewrite time (t_conf and the total interval time (Δ_conf), and a device is determined.

Then, in the example shown in FIG. 9, “Config-5” is also extracted as a circuit configuration where latency exceeding single clock occurs, and assignment of a device to the second circuit configuration section 20 is determined by performing similar processing.

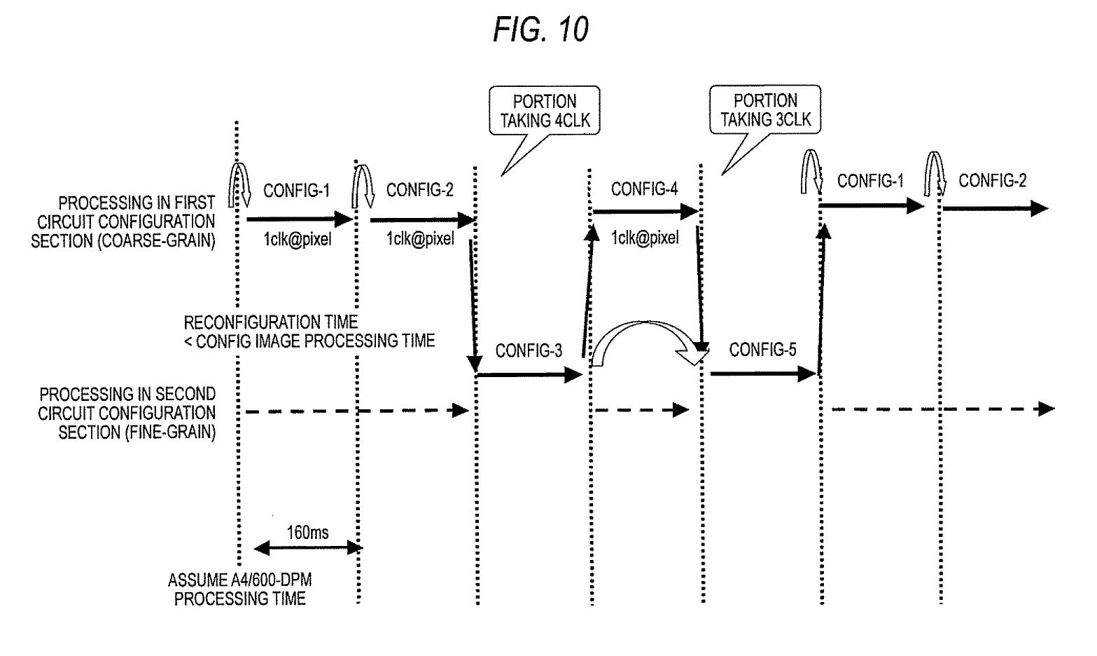

FIG. 10 is a timing chart describing the processing operation according to the first scheduling. In the figure, the upper stage shows the processing timing in the first circuit configuration section 10 (coarse-grain) and the lower stage shows the processing timing in the second circuit configuration section 20 (fine-grain). “Config-1” and “Config-2” are configured in the first circuit configuration section 10 and one pixel is processed for each single clock. Next, processing is performed in “Config-3” configured in the second circuit configuration section 20. Here, processing taking four clocks in the first circuit configuration section 10 is performed in a single clock.

Next, processing is performed in “Config-4” configured in the first circuit configuration section 10 and then processing is performed in “Config-5” configured in the second circuit configuration section 20. Here, processing taking three clocks in the first circuit configuration section 10 is performed in a single clock.

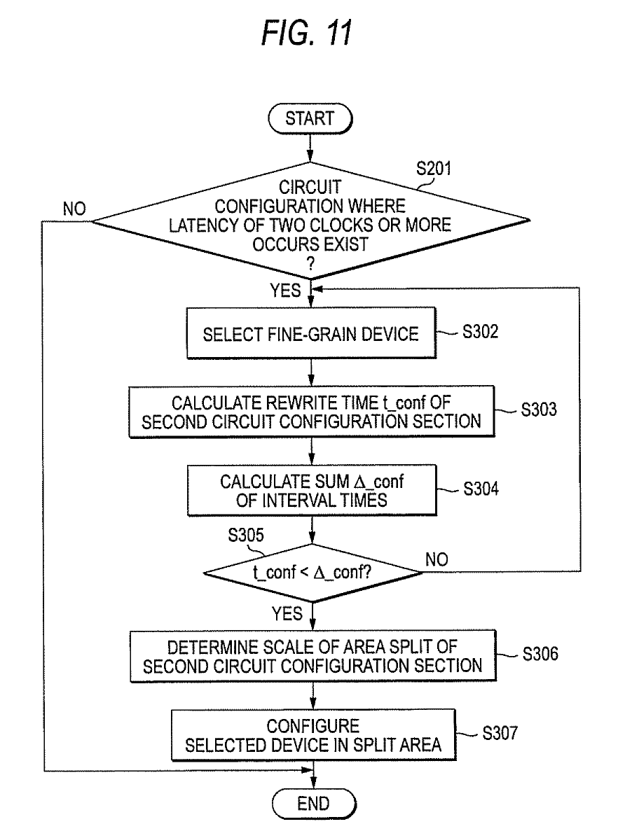

FIG. 11 is a flowchart describing second scheduling. FIG. 11 shows processing of speeding up using a partial reconfiguration function of the second circuit configuration section 20. Processing in the flowchart is executed in the scheduler 32 of the circuit configuration controller 30. To begin with, a circuit configuration with the processing time becoming a predetermined threshold value (here, two clocks) or more in the circuit configuration (Config) of desired information processing is extracted (step S301). The processing time of the circuit configuration is determined by referencing the management table shown in FIG. 4A. According to the determination, for example, a circuit configuration where latency of two clocks or more occurs in processing per pixel by processing of feedback, etc., is extracted. If a circuit configuration (Config) where latency occurs is not extracted, the processing is terminated.

Next, if a circuit configuration (Config) where latency of two clocks or more occurs is extracted, for the circuit configuration, circuit configuration in the second circuit configuration section 20 including the fine-grain computing units is selected (step S302). In this processing the selection table shown in FIG. 4B is referenced and a device (combination configuration of the fine-grain computing units) is selected in the order starting at the highest priority.

Next, rewrite time (t_conf) of the second circuit configuration section 20 when the selected device is used is calculated (step S303). The rewrite time (t_conf) is calculated according to the rewrite time per gate bit of the logic element (LE).

Next, sum Δ_conf of interval times of the circuit configurations (Config) is calculated (step S304). Whether or not the rewrite time (t_conf) is smaller than the total interval time (Δ_conf) is determined (step S305). If the rewrite time (t_conf) is smaller than the total interval time (Δ_conf), the scale of the area split of the second circuit configuration section 20 is determined (step S306). Then, the previously selected device is configured in the split area of the second circuit configuration section 20 determined (step S307).

On the other hand, if the rewrite time (t_conf) is not smaller than the total interval time (Δ_conf), the process returns to step S302 and the device having the next priority is selected out of the selection table and the later processing is repeated.

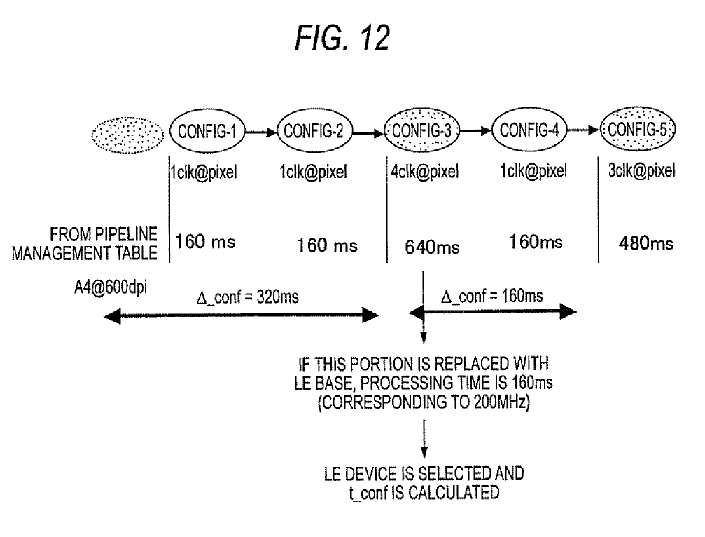

FIG. 12 is a diagram of the pipeline describing the second scheduling. In the example shown in FIG. 12, “Config-1” to “Config-5” are circuit configurations and each of “Config-1,” “Config-2,” and “Config-4” is processing in a single clock per pixel, “Config-3” is processing in four clocks per pixel, and “Config-5” is processing in three clocks per pixel. In the second scheduling, “Config-3” is extracted as a circuit configuration where latency of two clocks or more occurs.

If extracted “Config-3” is assigned to the second circuit configuration section 20 including the fine-grain computing units, the processing time becomes 160 ms like that of “Config-1,” “Config-2,” “Config-4.” The rewrite time (t_conf) when “Config-3” is assigned to the second circuit configuration section 20 is calculated. A comparison is made between the rewrite time (t_conf) and the total interval time (Δ_conf), and the device is assigned to the split area of the second circuit configuration section 20.

Then, in the example shown in FIG. 12, “Config-5” is also extracted as a circuit configuration where latency of two clocks or more occurs, and device is assigned to another split area of the second circuit configuration section 20 by performing similar processing.

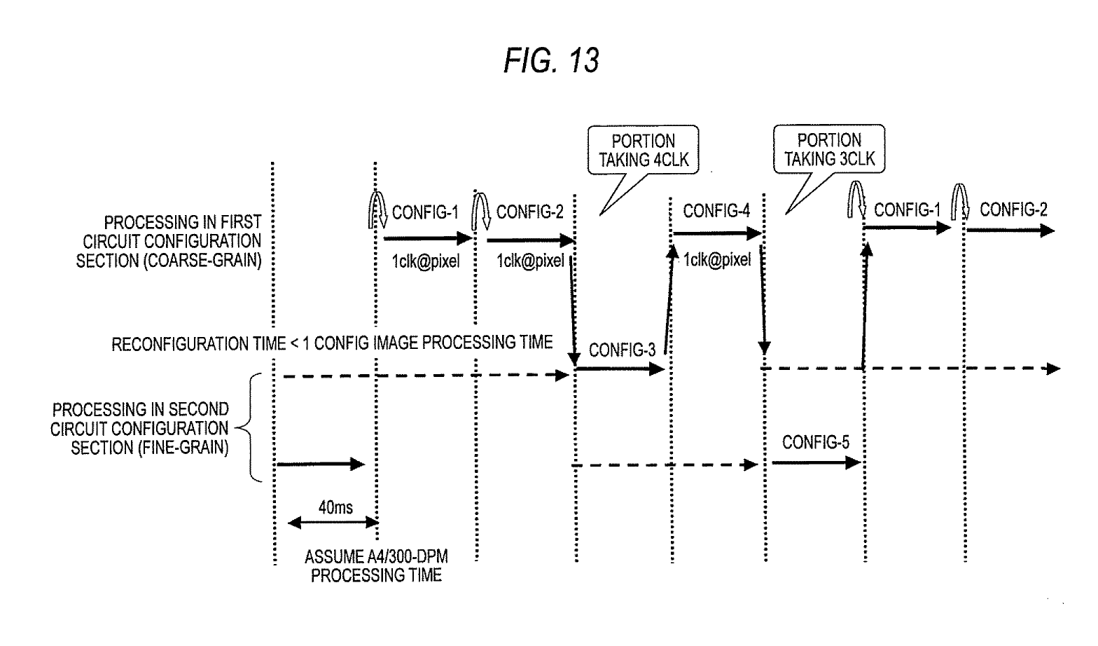

FIG. 13 is a timing chart describing the processing operation according to the second scheduling. In the figure, the upper stage shows the processing timing in the first circuit configuration section 10 (coarse-grain) and the lower stage shows the processing timing in the second circuit configuration section 20 (fine-grain). “Config-1” and “Config-2” are configured in the first circuit configuration section 10 and one pixel is processed for each single clock. Next, processing is performed in “Config-3” configured in one of the two split areas of the second circuit configuration section 20. Here, processing taking four clocks in the first circuit configuration section 10 is performed in a single clock.

Next, processing is performed in “Config-4” configured in the first circuit configuration section 10 and then processing is performed in “Config-5” configured in the other of the two split areas of the second circuit configuration section 20. Here, processing taking three clocks in the first circuit configuration section 10 is performed in a single clock.

The second circuit configuration section 20 is split and different devices are assigned to the split areas, so that while processing is performed in the device assigned to one area, rewriting time of the device assigned to the other area is provided. Therefore, a margin occurs in the circuit configuration rewrite time as compared with the case where the second circuit configuration section 20 is not split. Since rewrite is executed for each split area, the rewrite data amount lessens and the rewrite time is shortened.

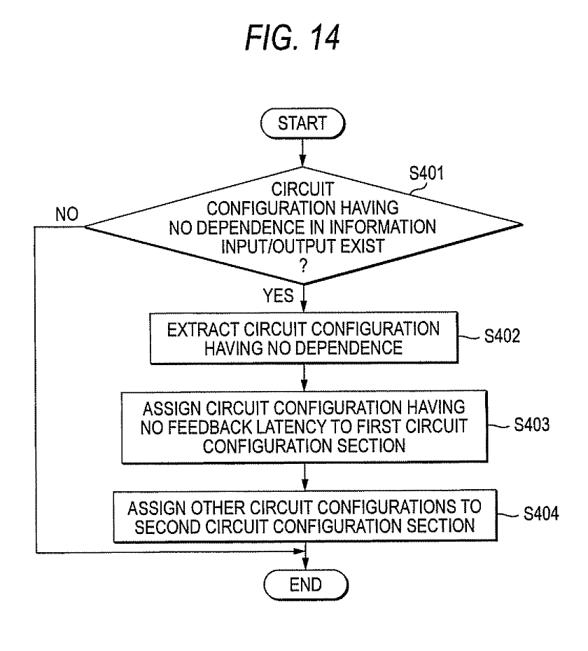

FIG. 14 is a flowchart describing third scheduling. Processing in the flowchart is executed in the scheduler 32 of the circuit configuration controller 30. To begin with, whether or not a circuit configuration (Config) having no dependence in information input/output exists is determined (step S401). If a circuit configuration having no dependence does not exist, the processing is terminated.

On the other hand, if a circuit configuration having no dependence exists, the circuit configuration (Config) is extracted (step S402). Next, from among the extracted circuit configurations, a circuit configuration having no latency involved in feedback is assigned to the first circuit configuration section 10 (step S403) and other circuit configurations are assigned to the second circuit configuration section 20 (step S404).

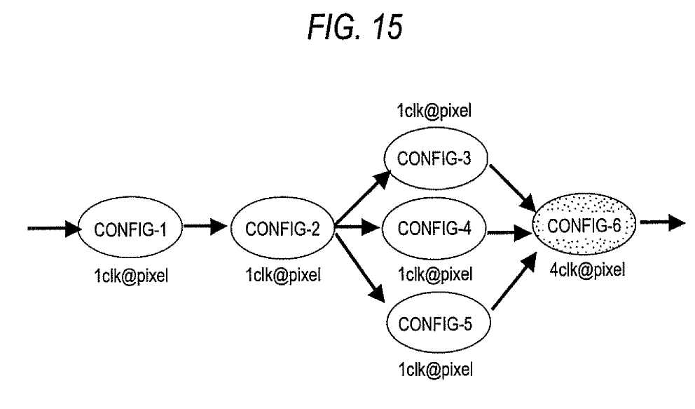

FIG. 15 is a diagram of the pipeline describing the third scheduling. In the example shown in FIG. 15, “Config-1” to “Config-6” are circuit configurations and each of “Config-1” to “Config-5” is processing in a single clock per pixel, and “Config-6” is processing in four clocks per pixel. In the third scheduling, “Config-3” to “Config-5” having no dependence in information input/output are extracted.

From extracted “Config-3” to “Config-5,” “Config-3” having no latency involved in feedback is assigned to the first circuit configuration section 10 and other circuit configurations “Config-4” and “Config-5” are assigned to the second circuit configuration section 20.

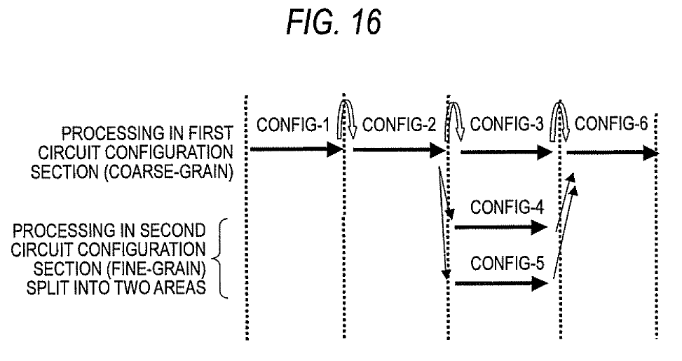

FIG. 16 is a timing chart describing the processing operation according to the third scheduling. In the figure, the upper stage shows the processing timing in the first circuit configuration section 10 (coarse-grain) and the lower stage shows the processing timing in the second circuit configuration section 20 (fine-grain) split into two areas.

“Config-1” and “Config-2” are configured in the first circuit configuration section 10 and one pixel is processed for each single clock. Next, “Config-3” is configured in the first circuit configuration section 10 and “Config-4” and “Config-5” are configured in the two split areas of the second circuit configuration section 20 and parallel processing is performed. Next, “Config-6” is configured in the first circuit configuration section 10 and processing is performed.

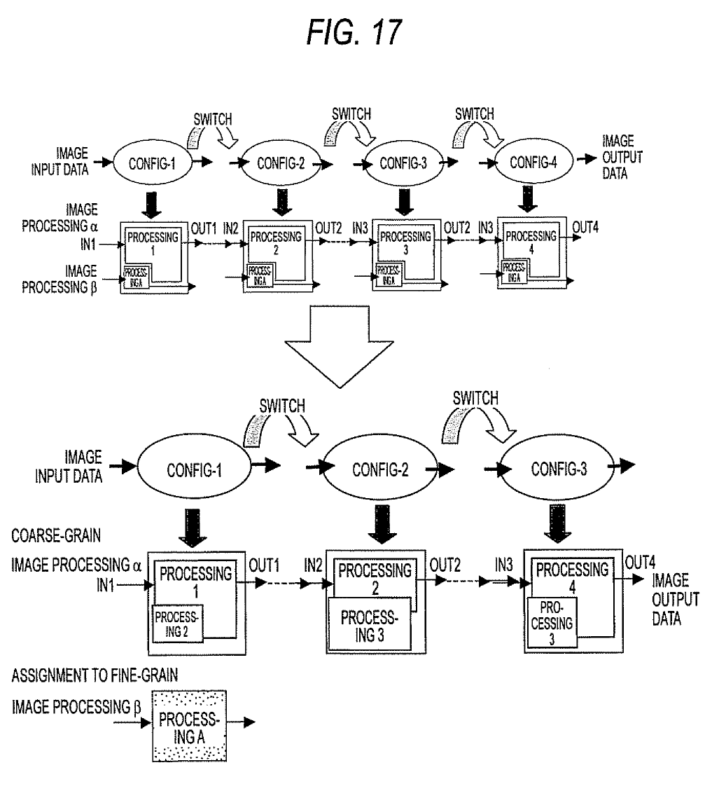

FIG. 17 is a diagram of the pipeline describing fourth scheduling. The upper portion of FIG. 17 is a drawing showing a flow before the fourth scheduling is performed, and the lower portion of FIG. 17 is a drawing showing a flow after the fourth scheduling is performed.

As shown in the upper portion of FIG. 17, in the flow before the fourth scheduling is performed, “Config-1” to “Config-4” are circuit configurations. All the circuit configurations are configured in the first circuit configuration section 10 including the fine-grain computing units.

The circuit configurations of “Config-1” to “Config-4” contain processing A as a circuit for performing the same processing. That is, in the example, processing 1 for image processing α and processing A for image processing β are configured as “Config-1,” processing 2 for image processing α and processing A for image processing β are configured as “Config-2,” processing 3 for image processing α and processing A for image processing β are configured as “Config-3,” and processing 4 for image processing α and processing A for image processing β are configured as “Config-4.”

For example, processing A in image processing β is scan processing and the path of image processing β is placed in a state in which scan data can be accepted at any time. Thus, processing A is contained in all circuit configurations.

In the fourth scheduling, the same processing in each circuit configuration is thus assigned to the second circuit configuration section 20 including the fine-grain computing units. That is, as shown in the lower portion of FIG. 17, processing A is assigned to the second circuit configuration section 20 including the fine-grain computing units, and processing of image processing α is assigned to each empty area in the first circuit configuration section 10.

Specifically, processing 1 for image processing α is configured and processing 2 is configured in the area of processing A as “Config-1” of the first circuit configuration section 10, processing 2 for image processing α is configured and a part of processing 3 is configured in the area of processing A as “Config-2,” and processing 4 for image processing α is configured and the remaining part of processing 3 is configured in the area of processing A as “Config-3.” Accordingly, the number of circuit configurations is decreased to three from four. This means that the processing performance improves to 4/3=about 1.33 times.

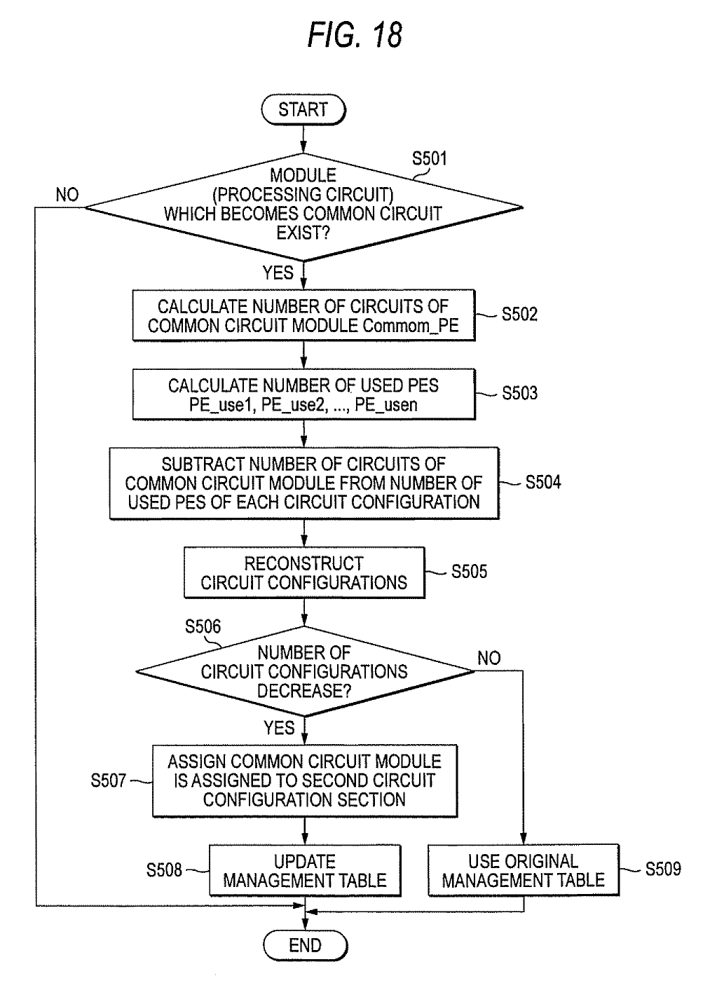

FIG. 18 is a flowchart describing the fourth scheduling. Processing in the flowchart is executed in the scheduler 32 of the circuit configuration controller 30. To begin with, whether or not a module (processing circuit) which becomes common to the circuit configurations exists is determined (step S501). If no common module exists, the processing is terminated. If a common module exists, the number of circuits of the module of the common circuit is calculated (step S502). The calculated number of circuits is Common_PE.

Next, the management table shown in FIG. 4A is referenced and the number of used PEs (PE_use1, PE_use2, . . . , PE_usen) of the circuit configuration (Config) is extracted (step S503). Next, the number of circuits of the module of the common circuit, Common_PE, is subtracted from the extracted number of used PEs (step S504).

The circuit configurations are reconstructed according to the number of PEs after calculation (step S505). In the processing, the circuit configurations are reconstructed in a state in which the number PEs of the common circuit module is empty. Then, whether or not the number of circuit configurations (Configs) after reconstruction decreases from that before reconstruction is determined (step S506). If the number of circuit configurations decreases, the common circuit module is assigned to the second circuit configuration section 20 including the fine-grain computing units (step S507), and the management table shown in FIG. 4A is rewritten to the value found after calculation at step S504 (step S508).

On the other hand, if the number of circuit configurations (Configs) after reconstruction does not decrease from that before reconstruction, assignment of the common circuit module to the fine-grain computing units is not executed and the original management table remains unchanged (step S509).

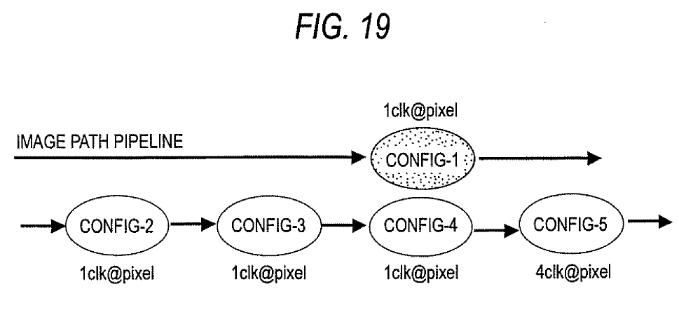

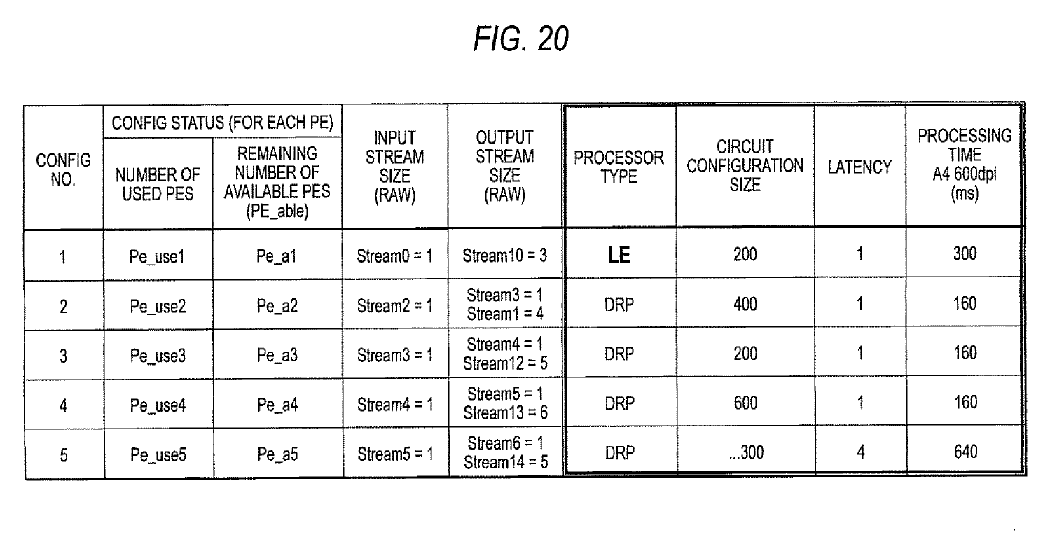

FIG. 19 is a diagram of the pipeline after the fourth scheduling is performed. FIG. 20 is a drawing showing an example of the management table after the fourth scheduling is performed. If a common circuit module to the circuit configurations (Configs) is extracted by executing the fourth scheduling, the common circuit module is assigned to the second circuit configuration section 20 including the fine-grain computing units. In the example shown in FIGS. 19 and 20, the management table is updated with the circuit configuration of the common circuit module assigned to the second circuit configuration section 20 as “Config-1.” In the management table shown in FIG. 20, the processor type corresponding to “Config-1” is logic element (LE) indicating the fine-grain unit.

As shown in FIG. 19, a line of “Config-1” and a line of “Config-2” to “Config-5” are provided in parallel as the pipeline flow after the fourth scheduling.

The flow of each scheduling described above may be implemented as an information processing program executed in the information processing apparatus. The information processing program is recorded on a record medium such as a CD-ROM or is distributed through a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first circuit configuration section that includes a first circuit configuration configured by a plurality of first calculation units, each of the first calculation units having a circuit being configured to be dynamically reconfigured;
a second circuit configuration section that includes a second circuit configuration configured by a plurality of second calculation units, each of the second calculation units having a fixed circuit; and
a circuit configuration controller that controls the first circuit configuration and the second circuit configuration in accordance with processing time to be taken for performing information processing.

2. The information processing apparatus according to claim 1, wherein the first calculation units have a larger grain size than the second calculation units.

3. The information processing apparatus according to claim 1, wherein the first circuit configuration is changed in a shorter time than the second circuit configuration.

4. The information processing apparatus according to claim 1, wherein
each of the first calculation units is configured by a plurality of calculation circuits, and
each of the second calculation units is configured by a single calculation circuit.

5. The information processing apparatus according to claim 1, wherein the circuit configuration controller controls the first circuit configuration when performing information processing that does not use a processing result of first information for performing processing of second information.

6. The information processing apparatus according to claim 1, wherein the circuit configuration controller controls the second circuit configuration when performing information processing that uses a processing result of first information for performing processing of second information.

7. The information processing apparatus according to claim 1, wherein the circuit configuration controller controls the first circuit configuration using a part of the first calculation units of the first circuit configuration section.

8. The information processing apparatus according to claim 1, wherein the circuit configuration controller controls the second circuit configuration using a part of the second calculation units of the second circuit configuration section.

9. The information processing apparatus according to claim 1, wherein
the circuit configuration controller divides the second circuit configuration section into a plurality of areas, and
the circuit configuration controller controls the second circuit configuration to change circuit configuration of a target area included in the areas while the target area is not performing the information processing.

10. A method for controlling information processing apparatus, wherein the information processing apparatus includes
a first circuit configuration section that includes a first circuit configuration configured by a plurality of first calculation units, each of the first calculation units having a circuit being configured to be dynamically reconfigured, and
a second circuit configuration section that includes a second circuit configuration configured by a plurality of second calculation units, each of the second calculation units having a fixed circuit, and
the method comprises controlling the first circuit configuration and the second circuit configuration in accordance with processing time to be taken for performing information processing.

11. A computer readable medium storing a program causing a computer to execute a process for controlling an information processing apparatus,
wherein the information processing apparatus includes
a first circuit configuration section that includes a first circuit configuration configured by a plurality of first calculation units, each of the first calculation units having a circuit being configured to be dynamically reconfigured, and
a second circuit configuration section that includes a second circuit configuration configured by a plurality of second calculation units, each of the second calculation units having a fixed circuit, and
the process comprises controlling the first circuit configuration and the second circuit configuration in accordance with processing time to be taken for performing information processing.
